(19) United States
(12) Patent Application Publication
(10) Pub. No.: US 2021/0241675 A1
(43) Pub. Date: Aug. 5, 2021

(54) DISPLAY UNIT ILLUMINATION

(71) Applicant: Hewlett-Packard Development Company, L.P., Spring, TX (US)

(72) Inventor: Lee Atkinson, Taipei (TW)

(73) Assignee: Hewlett-Packard Development Company, L.P., Spring, TX (US)

(21) Appl. No.: 17/048,733

(22) PCT Filed: Oct. 18, 2018
(86) PCT No.: PCT/US2018/056581

§ 371 Date: Oct. 19, 2020

(51) Int. Cl. G09G 3/22

(52) U.S. Cl. CPC G09G 3/22; G09G 2310/08

(57) ABSTRACT

Examples of illumination of display units are described. In an example, a display unit is illuminated for a first portion of a time period to display a display frame. The time period is a threshold time period. Further, the display unit is illuminated for an additional portion of the time period after the time period in response to determination of a frame absence condition at an end of the time period.

### BACKGROUND

Display systems, such as televisions, laptops, tablets, and mobile phones, may have a display unit for displaying content to users. The display unit of such systems may include a liquid crystal display (LCD) screen, a light emitting diode (LED) display screen, an organic LED display screen, or the like. The LEDs may be backlit, or the organic LEDs may be activated, to display contents on the display unit.

### BRIEF DESCRIPTION OF DRAWINGS

The following detailed description references the drawings, wherein:

FIG. 1 illustrates a block diagram of a system with a display unit, according to an example;

FIG. 2 illustrates a block diagram of a system with a display unit, according to an example;

FIG. 3 illustrates illumination timings of the display unit, according to an example;

FIG. 4 illustrates illumination timings of the display unit, according to an example;

FIG. 5 illustrates a method for illumination of a display unit, according to an example; and

FIG. 6 illustrates a system environment implementing a non-transitory computer-readable medium for illumination of a display unit, according to an example.

### DETAILED DESCRIPTION

A display system may display content on a display unit by processing and rendering of display frames serially onto the display unit and illuminating the display unit in response to rendering of the display frames. The display frames may be processed and rendered based on the content that is to be displayed.

In a pseudo-impulse display system, the display unit may be switched ON and illuminated for a predefined time in response to rendering of a display frame, and then switched OFF prior to rendering of a subsequent display frame. The predefined time may depend on the rate at which the display frames are rendered on the display unit. The switching OFF of the display unit may be referred to as “black frame insertion”. In an example, the display frames may be rendered at a frame rate of 100 Hz in the pseudo-impulse display system. The display unit of the pseudo-impulse display system may be switched ON synchronously, at the frame rate, for 3 milliseconds (ms) and switched OFF for 7 ms, giving a duty cycle of 30%. The duty cycle of the display unit of the pseudo-impulse display system may also be referred to as a relative illumination of the display unit. Contents displayed on the pseudo-impulse display systems may be perceived as natural to the human eye and may exhibit less motion blur.

For applications such as high-speed gaming, some display frames may take a bit longer to process and render in comparison to other frames. Thus, the display frames may be rendered at an asynchronous, or non-periodic, frame rate. The display frames that take a longer time to process, i.e., have a longer render time, may introduce an additional switch OFF time of the display unit in a pseudo-impulse display system. This additional switch OFF time may lead to reduction in the relative illumination which may cause displays from the display unit of the pseudo-impulse display system to flicker.

The present subject matter describes approaches for illuminating a display unit of a pseudo-impulse display system. The approaches of the present subject matter facilitate reduction of flickering of displays from the display unit of the pseudo-impulse display system.

According to an example implementation of present subject matter, a display unit of a pseudo-impulse display system is illuminated for a first portion of a time period to display a display frame. The time period herein corresponds to a threshold time period. In an example, the threshold time period may be the minimum time period in which display frames can be processed and rendered onto the display unit. The minimum time period corresponds to the maximum frame rate of the pseudo-impulse display system. The first portion of the time period may be in a range of 25% to 35% of the time period.

At an end of the time period, it is checked whether a subsequent display frame is rendered onto the display unit or not. When no subsequent display frame is rendered at the end of the time period, which is referred to as a frame absence condition, the display unit is illuminated for an additional portion of the time period after the time period. The additional portion of the time period may be smaller than the first portion of the time period.

In an example, in case the frame absence condition is determined at the end of the time period, the display unit is illuminated, at the end of the time period, for the additional portion of the time period after every second portion of the time period until the subsequent display frame is rendered onto the display unit. The second portion of the time period may be smaller than the first portion and greater than the additional portion of the time period.

In another example, in case the frame absence condition is determined at the end of the time period, the display unit is illuminated for the additional portion of the time period at the end of the first portion of the time period for which the subsequent display frame is displayed. The display unit may be illuminated for the additional portion at the end of the first portion multiple times based a time delay in receiving the subsequent display frame from the end of the time period.

Illumination of the display unit for the additional portion of the time period in response to determination of the frame absence condition at the end of the time period effectively increases the switch ON time of the display unit in the pseudo-impulse display system working with a non-periodic frame rate. Increase in the switch ON time increases the relative illumination of the display unit, thereby reducing the flickering of displays from the display unit.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

The articles “a”, “an” and “the” are used to refer to one or to more than one (i.e., to at least one) of the grammatical object of the article. The term “about” when referring to a numerical value is intended to encompass the values resulting from variations that can occur during the normal course of performing a method. Such variations are usually within plus or minus 5 to 10 percent of the stated numerical value. The terms “first” and “second”, and “additional” are used for differentiating one portion of a time period from another portion of the time period, and these portions should not be limited by these terms. Thus, a first portion described herein could be termed a second portion without departing from the teachings of the present subject matter.

It should be further understood that the terms “comprises”, “comprising,”, “has”, “having”, “includes” and/or “including”, when used herein, specify the presence of stated features, steps, operations, elements, and/or components, but do not preclude the presence or addition of one or more other features, steps, operations, elements, components, and/or groups thereof.

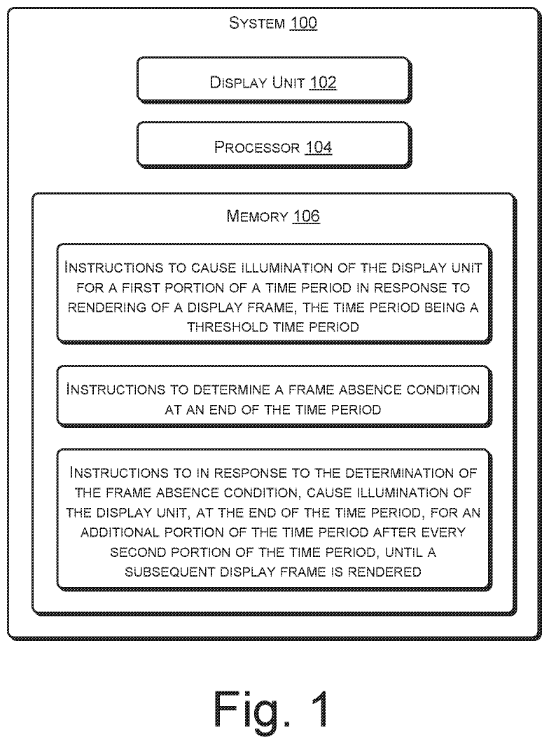

FIG. 1 illustrates a block diagram of a system 100 with a display unit 102, according to an example. The system 100 may be a pseudo-impulse display system. The system 100 may be implemented as an electronic device, for example, a television, a laptop, a tablet, a mobile phone, and the like. The display unit 102 may be implemented as an LCD screen, an LED display screen, an organic LED display screen, and the like. The system 100 includes a processor 104 coupled to the display unit 102 and a memory 106 coupled to the processor 104. The processor 104 may refer to as a processing resource implemented as microprocessors, microcomputers, microcontrollers, digital signal processors, central processing units, state machines, logic circuitries, and/or any devices that manipulate signals based on operational instructions. Among other capabilities, the processor 104 may fetch and execute computer-readable instructions stored in the memory 106. The memory 106 may be a non-transitory computer-readable storage medium. The memory 106 may include, for example, volatile memory (e.g., RAM), and/or non-volatile memory (e.g., EPROM, flash memory, NVRAM, memristor, etc.).

In an example, the memory 106 stores instructions executable by the processor 104 to cause illumination of the display unit 102 for a first portion of a time period in response to rendering of a display frame. The time period is a threshold time period, for example, corresponding to a maximum frame rate at which display frames can be processed and rendered onto the display unit 102. The memory 106 also stores instructions executable by the processor 104 to determine a frame absence condition at an end of a time period and, in response to the determination of the frame absence condition, cause illumination of the display unit 102, at the end of the time period, for an additional portion of the time period after every second portion of the time period. The display unit 102 may be illuminated periodically for the additional portion after every second portion of the time period, until a subsequent display frame is rendered or received for displaying by the display unit 102. The memory 106 further stores instructions executable by the processor 104 to cause illumination of the display unit 102 for the first portion of the time period, in response to rendering or receiving the subsequent display frame, to display the subsequent display frame.

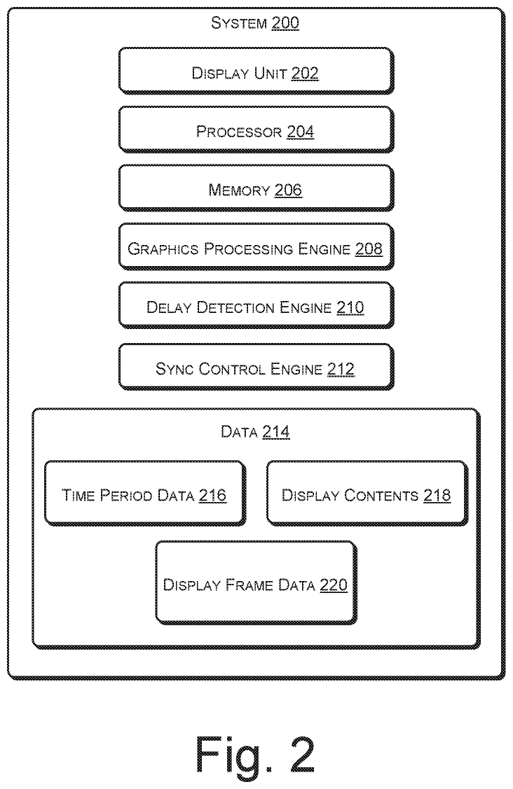

In an example, the second portion is greater than the additional portion and smaller than the first portion. In an example, the first portion of the time period is in a range of 25% of the time period to 35% of the time period. In an example, the second portion of the time period is in a range of 9% of the time period to 11% of the time period. In an example, the additional portion of the time period is in a range of 2.5% of the time period to 3.5% of the time period. Aspects described above with respect to FIG. 1 for illuminating the display unit 102 with reduced flickering are further described in detail with respect to FIG. 2.

FIG. 2 illustrates a block diagram of a system 200 with a display unit 202, according to an example. The system 200 may be implemented as an electronic device, for example, a television, a laptop, a tablet, a mobile phone, and the like. The display unit 202 may be implemented as an LCD screen, an LED display screen, an organic LED display screen, and the like. The system 200 includes a processor 204, similar to the processor 104 of the system 100, and includes a memory 206, similar to the memory 106 of the system 100. Further, as shown in FIG. 2, the system 200 includes a graphics processing engine 208, a delay detection engine 210, and a sync control engine 212. The graphics processing engine 208, the delay detection engine 210, and the sync control engine 212 may collectively be referred to as engine(s) which can be implemented through a combination of any suitable hardware and computer-readable instructions. The engine(s) may be implemented in a number of different ways to perform various functions for the purposes of processing and rendering display frames onto the display unit 202 and accordingly illuminating the display unit 202 to display the display frames. For example, the computer-readable instructions for the engine(s) may be processor-executable instructions stored in a non-transitory computer-readable storage medium, and the hardware for the engine(s) may include a processing resource to execute such instructions. In some examples, the memory 206 may store instructions which, when executed by the processor 204, implement the graphics processing engine 208, the delay detection engine 210, and the sync control engine 212. Although, the memory 206 is shown to reside in the system 200; however, in an example, the memory 206 storing the instructions may be external, but accessible to the processor 204 of the system 200. In another example, the engine(s) may be implemented by electronic circuitry.

Further, as shown in FIG. 2, the system 200 includes data 214. The data 214, amongst other things, serves as a repository for storing data that may be fetched, processed, received, or generated by the graphics processing engine 208, the delay detection engine 210, and the sync control engine 212. The data 214 includes time period data 216, display contents 218, and display frame data 220. In an example, the data 214 may reside in the memory 206. Further, in some examples, the data 214 may be stored in an external database, but accessible to the processor 204 of the system 200.

The description hereinafter describes example procedures of processing and rendering display frames onto the display unit 202 and accordingly illuminating the display unit 202 to display the display frames with reduced flickering.

In an example, the graphics processing engine 208 may fetch data pertaining to contents to be displayed on the display unit 202 from the display contents 218. The graphics processing engine 208 may process the data fetched from the display contents 218 to generate display frames and render the generated display frames onto the display unit 202 for displaying. The graphics processing engine 208 may serially, i.e., one after another, generate and render the display frames. The generated display frames may be stored in the display frame data 220.

In response to rendering of a display frame from the graphics processing engine 208 onto the display unit 202, the sync control engine 212 may switch ON the display unit 202 for a first portion of a time period to illuminate the display unit 202 to display the display frame. The time period is a threshold time period indicated, for example, by the maximum frame rate for the system 200. The delay detection engine 210 determines whether a subsequent display frame, i.e., a new display frame, is rendered onto the display unit 202 at an end of the time period. The delay detection engine 210 determines a frame absence condition in case no display frame is received from, or rendered by, the graphics processing engine 208 at the end of the time period.

In an example, in response to the determination of the frame absence condition at the end of the time period, the sync control engine 212 switches ON the display unit 202 to illuminate the display unit 202 for an additional portion of the time period after every second portion of the time period, until the subsequent display frame is received from the graphics processing engine 208 or rendered onto the display unit 202. In response to rendering of the subsequent display frame, the sync control engine 212 again switches ON the display unit 202 to illuminate the display unit 202 for the first portion of the time period to display the subsequent display frame. Data pertaining to the threshold time period, the first portion, the second portion, and the additional portion, are stored in the time period data 216.

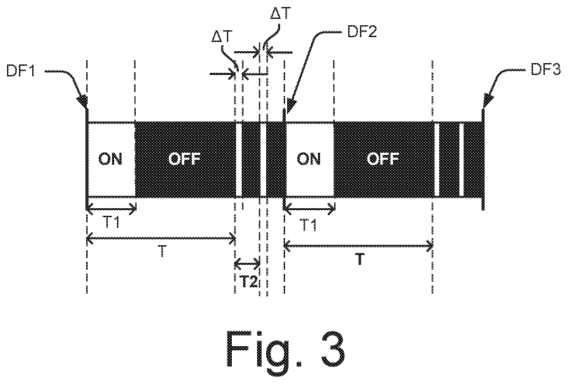

FIG. 3 illustrates illumination timings of the display unit 202, according to an example. For the purpose of description herein, consider a case that a display frame, DF1, is initially rendered onto the display unit 202, and the minimum time period that the graphics processing engine 208 take to process and render a display frame is T. In response to rendering of the display frame DF1 from the graphics processing engine 208 onto the display unit 202, the sync control engine 212 switches ON the display unit 202 for a first portion, T1, of the time period T to illuminate the display unit 202 to display the display frame DF1. The sync control engine 212 switches OFF the display unit 202 at the end of the first portion T1 of the time period T. At the end of the time period T, the delay detection engine 210 checks and determines for the frame absence condition. As shown in FIG. 3, a subsequent display frame, DF2, is not received and rendered at the end of the time period T. In response to the determination of the frame absence condition at the end of the time period T by the delay detection engine 210, the sync control engine 212 switches ON the display unit 202 for an additional portion, ΔT, of the time period T. The sync control engine 212 switches OFF the display unit 202 at the end of the additional portion ΔT of the time period T. The sync control engine 212 periodically switches ON the display unit 202 for the additional portion ΔT after every second portion, T2, of the time period T, until the subsequent display frame DF2 is received and rendered.

In response to rendering of the subsequent display frame DF2, the sync control engine 212 switches ON the display unit 202 for the first portion T1 of the time period T. The sync control engine 212 switches OFF the display unit 202 at the end of the first portion T1, after which the determination of the frame absence condition at the end of the time period T is repeated in respect of a further display frame, DF3, in the same manner, as described above.

In another example, after the determination of the frame absence condition at the end of the time period, the sync control engine 212 switches ON the display unit 202 to illuminate the display unit 202 for the first portion of the time period in response to rendering of the subsequent display frame by the graphics processing engine 208 onto the display unit 202. At the end of the first portion of the time period, the sync control engine 212 again switches ON the display unit 202 to illuminate the display unit 202 for an additional portion of the time period to display the subsequent display frame. The sync control engine 212 switches ON the display unit 202 for the additional portion at the end of the first portion multiple times based on a time delay in receiving the subsequent display frame from the end of the time period.

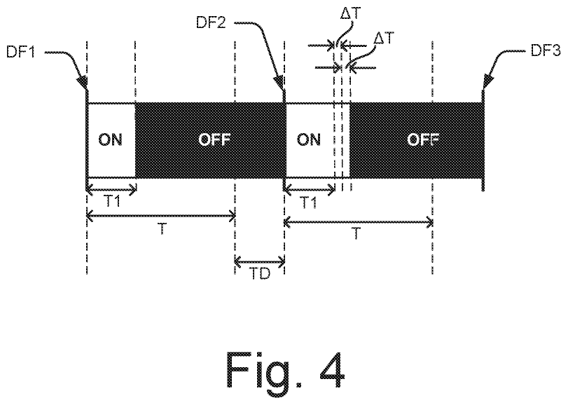

FIG. 4 illustrates illumination timings of the display unit 202, according to an example. Consider a case that a display frame, DF1, is initially rendered onto the display unit 202, and the minimum time period that the graphics processing engine 208 take to process and render a display frame is T. In response to rendering of the display frame DF1 from the graphics processing engine 208 onto the display unit 202, the sync control engine 212 switches ON the display unit 202 for a first portion, T1, of the time period T to illuminate the display unit 202 to display the display frame DF1. The sync control engine 212 switches OFF the display unit 202 at the end of the first portion T1 of the time period T. At the end of the time period T, the delay detection engine 210 checks and determines for the frame absence condition. As shown in FIG. 3, a subsequent display frame, DF2, is not received and rendered at the end of the time period T. The subsequent display frame DF2 is received after a time delay TD from the end of the time period T.

Upon receiving the subsequent display frame DF2, the sync control engine 212 switches ON the display unit 202 for the first portion T1 of the time period T. The sync control engine 212 keeps the display unit 202 switched ON for an additional portion, ΔT, of the time period T, after the end of the first portion T1 for which the subsequent display frame DF2 is displayed. The sync control engine 212 keeps the display unit 202 switched ON for integer multiples of the additional portion ΔT after the end of the first portion T1, depending on the time delay TD. In an example, the integer multiple of the additional portion ΔT is equal to Integer[TD/T2], where T2 is a second portion of the time period T smaller than the first portion T1 and greater than the additional portion ΔT. The sync control engine 212 switches OFF the display unit 202 at the end of the multiples of the additional portion ΔT, after which the determination of the frame absence condition at the end of the time period T is repeated in respect of a further display frame, DF3, in the same manner, as described above.

In an example, the first portion T1 is in a range of 25% of the time period T to 35% of the time period T, the second portion T2 is in a range of 9% of the time period T to 11% of the time period T, and the additional portion ΔT is in a range of 2.5% of the time period T to 3.5% of the time period T. In an example, the first portion T1 is about 30% of the time period T, the second portion T2 is about 10% of the time period T, and the additional portion ΔT is about 3% of the time period T. Table 1 enlists example values of the maximum frame rate, the time period T corresponding to the threshold or minimum time period for the maximum frame rate, the first portion T1 of the time period T, the second portion T2 of the time period T, and the additional portion ΔT of the time period T, with respect to the terminologies mentioned in FIG. 3.

TABLE 1

| | Time | | First | Second | | Additional |
|---|---|---|---|---|---|---|
| Maximum | Period | | Portion | Portion | | Portion |
| Frame Rate | (T) | | (T1) | (T2) | | (ΔT) |
| 100 Hz | 10 | ms | 3 ms | 1 | ms | 0.3 ms |
| 50 Hz | 20 | ms | 6 ms | 2 | ms | 0.6 ms |
| 200 Hz | 5 | ms | 1.5 ms | 0.5 | ms | 0.15 ms |
| 60 Hz | 16.67 | ms | 5 ms | 1.67 | ms | 0.5 ms |

Further, the display unit 202 when illuminated for the additional portion ΔT of the time period T may display the display frame that is presently rendered thereon. In an example, the display unit 202 may be illuminated for the additional portion ΔT of the time period T to display a white frame. For displaying a white frame, each pixel of the display unit 202 is set so as to display white color upon receiving a pixel drive or illumination signal.

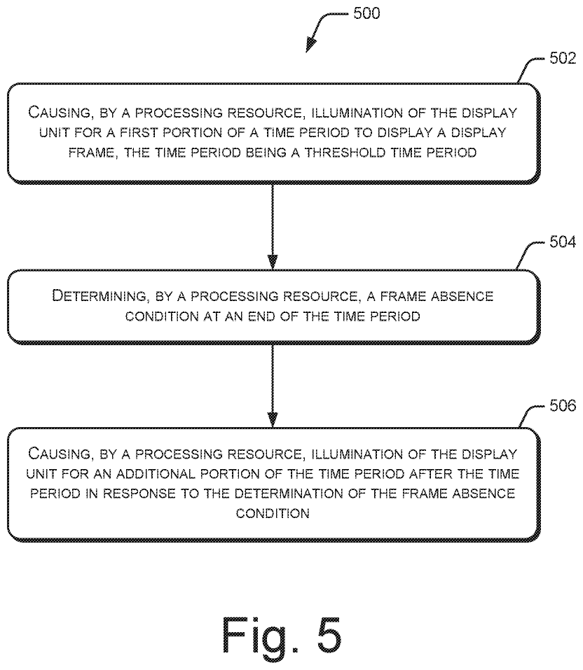

FIG. 5 illustrates a method 500 for illumination of a display unit, according to an example. The method 500 can be implemented by a processing resource or a system through any suitable hardware, a non-transitory machine-readable medium, or a combination thereof. In some examples, processes involved in the method 500 can be executed by a processing resource, for example the processor 104 or 204 based on instructions stored in a non-transitory computer-readable medium, for example the memory 106 or 206. The non-transitory computer-readable medium may include, for example, digital memories, magnetic storage media, such as a magnetic disks and magnetic tapes, hard drives, or optically readable digital data storage media.

The method 500 described herein is for illumination of a display unit 102, 202 of a system 100, 200. The same procedure, in accordance with the method 500, may be performed for illumination of any such display unit.

Referring to FIG. 5, at block 502, a processing resource causes illumination of a display unit for a first portion of a time period to display a display frame. The processing resource may be the processor 104 or 204, and the display unit may be the display unit 102 or 202. The time period referred to herein is a threshold time period. The threshold time period may be the minimum time period that is taken for processing and rendering of a display frame.

At block 504, a processing resource determines a frame absence condition at an end of the time period, and at block 506, a processing resource causes illumination of the display unit for an additional portion of the time period after the time period in response to the determination of the frame absence condition. Again, the processing resource referred to herein may be the processor 104 or 204. In an example, the additional portion of the time period is smaller than the first portion of the time period. The first portion may be in a range of 25% of the time period to 35% of the time period, and the additional portion may be in a range of 2.5% of the time period to 3.5% of the time period.

In an example, in response to the determination of the frame absence condition, the processing resource causes illumination of the display unit, at the end of the time period, for the additional portion of the time period after every second portion of the time period until a subsequent display frame is rendered. The second portion of the time period is smaller than the first portion and greater than the additional portion of the time period. The second portion of the time period is in a range of 9% of the time period to 11% of the time period.

Further, upon receiving the subsequent display frame, the processing resource again causes illumination of the display unit for the first portion of the time period, and the frame absence condition at the end of the time period is again check for and determined in a similar manner as described earlier.

In an example, after the determination of the frame absence condition, the processing resource causes illumination of the display unit for the first portion of the time period in response to rendering of the subsequent display frame. The processing resource also causes illumination of the display unit for the additional portion at the end of the first portion for which the subsequent display frame is displayed. The processing resource may cause illumination of the display unit for the additional portion multiple times based on a time delay in receiving the subsequent display frame from the end of the time period.

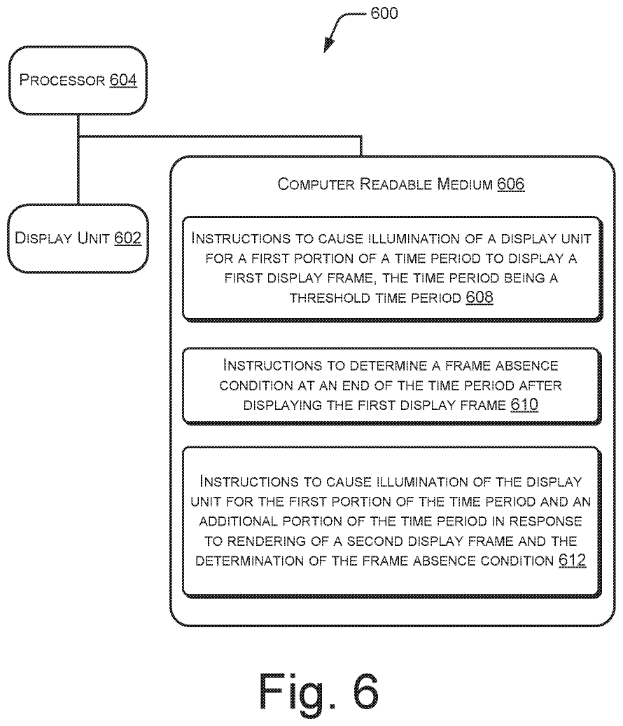

FIG. 6 illustrates a system environment 600 implementing a non-transitory computer-readable medium for illumination of a display unit 602, according to an example. The system environment 600 includes a processor 604 communicatively coupled to the non-transitory computer-readable medium 606. In an example, the processor 604 may be a processing resource of a system for fetching and executing computer-readable instructions from the non-transitory computer-readable medium 606. The system may be the system 100 or 200 as described with reference to FIGS. 1 and 2.

The non-transitory computer-readable medium 606 can be, for example, an internal memory device or an external memory device. In an example, the processor 604 may be communicatively coupled to the non-transitory computer-readable medium 606 through a communication link. The communication link may be a direct communication link, such as any memory read/write interface. In another example, the communication link may be an indirect communication link, such as a network interface. In such a case, the processor 604 can access the non-transitory computer-readable medium 606 through a communication network.

Referring to FIG. 6, in an example, the non-transitory computer-readable medium 606 includes instructions 608 to cause illumination of the display unit 602 for a first portion of a time period to display a first display frame. The time period is a threshold time period, as described earlier. The non-transitory computer-readable medium 606 includes instructions 610 to determine a frame absence condition at an end of the time period after displaying the first display frame, and includes instructions 612 to cause illumination of the display unit 602 for the first portion of the time period and an additional portion of the time period in response to rendering of a second display frame and determination of the frame absence condition. The additional portion is smaller than the first portion. In an example, the illumination for the additional portion at the end of the first portion is caused multiple times based on a time delay in receiving the second display frame from the end of the time period. The multiple times is equal to Integer[TD/T2], TD being the time delay and T2 being a second portion of the time period smaller than the first portion and greater than the additional portion.

In an example, the display unit 602 may be illuminated for the additional portion of the time period to display a white frame, as described earlier in the description. The first portion is in a range of 25% of the time period to 35% of the time period, the second portion is in a range of 9% of the time period to 11% of the time period, and the additional portion is in a range of 2.5% of the time period to 3.5% of the time period.

Although examples for the present disclosure have been described in language specific to structural features and/or methods, it is to be understood that the appended claims are not limited to the specific features or methods described herein. Rather, the specific features and methods are disclosed and explained as examples of the present disclosure.

We claim:

1. A method of illumination of a display unit, the method comprising:
causing, by a processing resource, illumination of the display unit for a first portion of a time period to display a display frame, the time period being a threshold time period;
determining, by a processing resource, a frame absence condition at an end of the time period; and
causing, by a processing resource, illumination of the display unit for an additional portion of the time period after the time period in response to the determination of the frame absence condition.

2. The method as claimed in claim 1, wherein the additional portion is smaller than the first portion.

3. The method as claimed in claim 1, wherein the illumination for the additional portion of the time period in response to the determination of the frame absence condition is caused at the end of the time period after every second portion of the time period until a subsequent display frame is rendered.

4. The method as claimed in claim 3, further comprising:
causing, by the processing resource, illumination of the display unit for the first portion of the time period in response to rendering of the subsequent display frame.

5. The method as claimed in claim 3, wherein the second portion is smaller than the first portion and greater than the additional portion.

6. The method as claimed in claim 1, further comprising:
causing, by the processing resource, illumination of the display unit for the first portion of the time period in response to rendering of a subsequent display frame,
wherein the illumination for the additional portion of the time period in response to the determination of the frame absence condition is caused at the end of the first portion of the time period for which the subsequent display frame is displayed.

7. The method as claimed in claim 6, wherein the illumination for the additional portion at the end of the first portion is caused multiple times based on a time delay in receiving the subsequent display frame from the end of the time period.

8. A system comprising:
a display unit;
a processor coupled to the display unit; and
a memory coupled to the processor, the memory storing instructions executable by the processor to:
cause illumination of the display unit for a first portion of a time period in response to rendering of a display frame, the time period being a threshold time period;
determine a frame absence condition at an end of the time period; and
in response to the determination of the frame absence condition, cause illumination of the display unit, at the end of the time period, for an additional portion of the time period after every second portion of the time period, until a subsequent display frame is rendered.

9. The system as claimed in claim 8, wherein the memory further stores instructions executable by the processor to:
cause illumination of the display unit for the first portion of the time period in response to rendering the subsequent display frame to display the subsequent display frame.

10. The system as claimed in claim 8, the second portion is smaller than the first portion and greater than the additional portion.

11. The system as claimed in claim 8, wherein:
the first portion is in a range of 25% of the time period to 35% of the time period;
the second portion is in a range of 9% of the time period to 11% of the time period; and
the additional portion is in a range of 2.5% of the time period to 3.5% of the time period.

12. A non-transitory computer-readable medium comprising computer-readable instructions, which, when executed by a processor, cause the processor to:
cause illumination of a display unit for a first portion of a time period to display a first display frame, the time period being a threshold time period;
determine a frame absence condition at an end of the time period after displaying the first display frame; and
cause illumination of the display unit for the first portion of the time period and an additional portion of the time period in response to rendering of a second display frame and the determination of the frame absence condition.

13. The non-transitory computer-readable medium as claimed in claim 12, wherein the additional portion is smaller than the first portion.

14. The non-transitory computer-readable medium as claimed in claim 12, wherein the illumination for the additional portion at the end of the first portion is caused multiple times based on a time delay in receiving the second display frame from the end of the time period.

15. The non-transitory computer-readable medium as claimed in claim 14, wherein the multiple times is equal to Integer[TD/T2], TD being the time delay and T2 being a second portion of the time period smaller than the first portion and greater than the additional portion.
